(19) United States
(12) Patent Application Publication
(10) Pub. No.: US 2026/0012062 A1
(43) Pub. Date: Jan. 8, 2026

(54) MOTOR DRIVEN PUMP FOR ELECTRIC ENGINE STARTS

(71) Applicant: Hamilton Sundstrand Corporation, Charlotte, NC (US)

(72) Inventors: Nicholas Schuster, Geneva, IL (US); Aaron M. Finke, Janesville, WI (US); Aaron Cooling, Rockford, IL (US)

(21) Appl. No.: 18/766,259

(22) Filed: Jul. 8, 2024

(51) Int. Cl. H02K 9/19; H02K 1/27; H02K 7/00; H02K 7/116

(52) U.S. Cl. CPC H02K 9/19; H02K 1/27; H02K 7/003; H02K 7/116

(57) ABSTRACT

An apparatus for driving an accessory includes an electric starter/generator (ESG) including a rotor shaft. The apparatus also includes a permanent magnet motor/generator (PMMG) associated with the rotor shaft. The apparatus also includes a gear coupled to a rotor of the PMMG for rotating in a first mode and for rotating in a second mode responsive to rotation of the rotor shaft, wherein rotation of the gear drives the accessory. The application of a current to a stator of the PMMG is configured to cause rotation of the rotor and the gear coupled to the rotor in the first mode when a rotation speed of the rotor is faster than a rotation speed of the rotor shaft. When the rotation speed of the rotor shaft equals the rotation speed of the rotor, the rotor is configured to engage the rotor shaft to rotate concurrently therewith in the second mode.

### TECHNICAL FIELD

This disclosure relates generally to oil pump drives for aircraft engine electric starter/generators (ESG). More specifically, this disclosure relates to a PMMG (permanent magnet motor/generator) pump drive during an aircraft electric engine start.

### BACKGROUND

Oil pumps associated with ESGs normally do not operate at full capacity during an electric start since their output is determined by the pump shaft speed. Oil flow throughout the ESG is a function of the ESG’s shaft speed when the pump is geared to the ESG rotor shaft, typical of the current state of the art. The ESG’s rotor shaft speed during an electric start can range from zero rpm to a percentage of the ESG’s minimum generate-mode speed, which can be anywhere from 25% to 75%, all while receiving full voltage and current from its motor controller. Pump speed, and thus oil flow, is also a fraction of its normal operation capacity. This can result in windings and other components becoming overheated while there is no to little oil flow. Thus, there is a need for enabling oil flow throughout the ESG before initiating a start operation of the ESG.

### SUMMARY

This disclosure relates to driving accessories associated with an electric starter/generator (ESG) before and during startup.

In a first example, an apparatus for driving an accessory comprises an electric starter/generator (ESG) including a rotor shaft. A permanent magnet motor/generator (PMMG) is associated with the rotor shaft of the ESG, the PMMG including a rotor and a stator. A gear coupled to the rotor of the PMMG is for rotating in a first mode responsive to rotation of the rotor of the PMMG and for rotating in a second mode responsive to rotation of the rotor shaft. The gear drives the accessory. Application of a current to the stator of the PMMG is configured to cause rotation of the rotor of the PMMG and the gear coupled to the rotor of the PMMG in the first mode when a rotation speed of the rotor of the PMMG is faster than a rotation speed of the rotor shaft of the ESG. When the rotation speed of the rotor shaft of the ESG equals the rotation speed of the rotor of the PMMG, the rotor of the PMMG is configured to engage the rotor shaft of the ESG to rotate concurrently therewith in the second mode.

In a second example, an apparatus comprises an electric starter/generator (ESG) including a rotor shaft. An outer concentric shaft surrounds a portion of the rotor shaft of the ESG. At least one bearing located between the outer concentric shaft and the rotor shaft of the ESG is configured to enable rotation of the outer concentric shaft around the rotor shaft of the ESG. A permanent magnet motor/generator (PMMG) is associated with the rotor shaft of the ESG. The PMMG includes a rotor and a stator. The rotor of the PMMG is fixedly connected to an outer surface of the outer concentric shaft. A gear is connected to the outer concentric shaft configured to rotate in a first mode responsive to rotation of the rotor of the PMMG and configured to rotate in a second mode responsive to rotation of the rotor shaft. Rotation of the gear is configured to drive an oil pump configured to provide oil to the ESG. Application of a current to the stator of the PMMG causes rotation of the rotor of the PMMG and the gear is connected to the outer concentric shaft in the first mode when a rotation speed of the rotor of the PMMG is faster than the rotation speed of the rotor shaft of the ESG. When the rotation speed of the rotor shaft of the ESG equals the rotation speed of the rotor of the PMMG, the outer concentric shaft of the PMMG is configured to engage the rotor shaft of the ESG to rotate concurrently therewith in the second mode.

In a third example, the method also includes associating a permanent magnet motor/generator (PMMG) including a rotor and a stator with the rotor shaft of an electric starter/generator (ESG), coupling a gear to the rotor of the PMMG, applying a current to the stator of the PMMG to cause rotation of the rotor of the PMMG, rotating the gear in a first mode responsive to rotation of the rotor of the PMMG when a rotation speed of the rotor of the PMMG is faster than the rotation speed of the rotor shaft of the ESG, wherein rotation of the gear drives an accessory associated with the ESG, engaging the rotor shaft of the ESG to rotate concurrently with the rotor of the PMMG in a second mode when the rotation speed of the rotor shaft of the ESG equals the rotation speed of the rotor of the PMMG, and rotating the gear in a second mode responsive to rotation of the rotor shaft, wherein rotation of the gear drives the accessory associated with the ESG.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates a block diagram of a system for powering an oil pump for an ESG prior to engine start;

FIG. 2 illustrates a perspective view of a PMMG (permanent magnet motor/generator) associated with the rotor shaft of an ESG used to drive a drive gear for operating an associated oil pump;

FIG. 3 illustrates a side view of the PMMG associated with the rotor shaft of an ESG;

FIG. 4 illustrates a cross-sectional view of the PMMG associated with the rotor shaft of an ESG; and

FIG. 5 illustrates a flow diagram of operation of the PMMG associated with the rotor shaft of an ESG.

### DETAILED DESCRIPTION

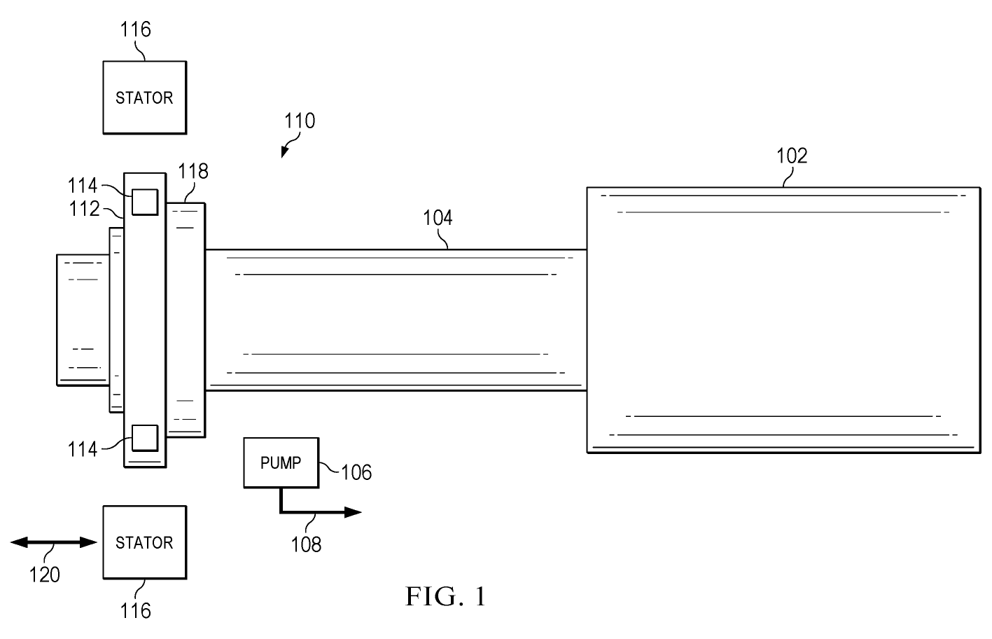

FIGS. 1 through 5, described below, and the various examples used to describe the principles of the present disclosure are by way of illustration only and should not be construed in any way to limit the scope of this disclosure. Those skilled in the art will understand that the principles of the present disclosure may be implemented in any type of suitably arranged device or system.

FIG. 1 illustrates a block diagram of a system for powering an oil pump for an ESG prior to engine start. The ESG 102 includes a rotor shaft 104 that rotates during operation of the ESG 102. Prior to start of the ESG 102, the oil pump 106 is not operating and is providing no oil via the output 108 to cool the associated components of the ESG 102. In order to overcome this problem during ESG 102 startup operations and prior to start up, a permanent magnet motor/generator (PMMG) 110 is associated with the rotor shaft 104 of the ESG 102. The PMMG 110 consist of a rotor 112 having a plurality of magnets 114 embedded therein that rotates with the rotor shaft 104 of the ESG 102. In normal generate-mode operation, the rotor 112 rotates the magnets 114 past a stator 116 of the PMMG 110 in order to generate electric power from the stator.

Prior to startup of the ESG 102, the oil pump 106 associated with the ESG is not operating and provides no oil at the output 108 for cooling the ESG components. In order to provide full operation of the oil pump 106 prior to and during startup, the PMMG rotor 112 may be connected to rotate independently of the rotor shaft 104. The PMMG rotor 112 may also be connected to a drive gear 118 that rotates concurrently with the PMMG rotor 112. The drive gear 118 also engages with the oil pump 106 (or other accessory) and drives the oil pump such that oil may be provided at the output 108 during and prior to ESG startup. The drive gear 118 is driven by rotation of the rotor 112 about the rotor shaft 104. Rotation of the PMMG rotor 112 is initiated by applying an alternating current 120 to the coils of the stator 116. This creates rotational forces upon the magnets 114 on the rotor 112 causing rotation of the rotor 112 which also causes rotation of the drive gear 118. Movement of the PMMG rotor 112 independent of the rotor shaft 104 is achieved using a one-way clutch mechanism as will be fully described hereinbelow.

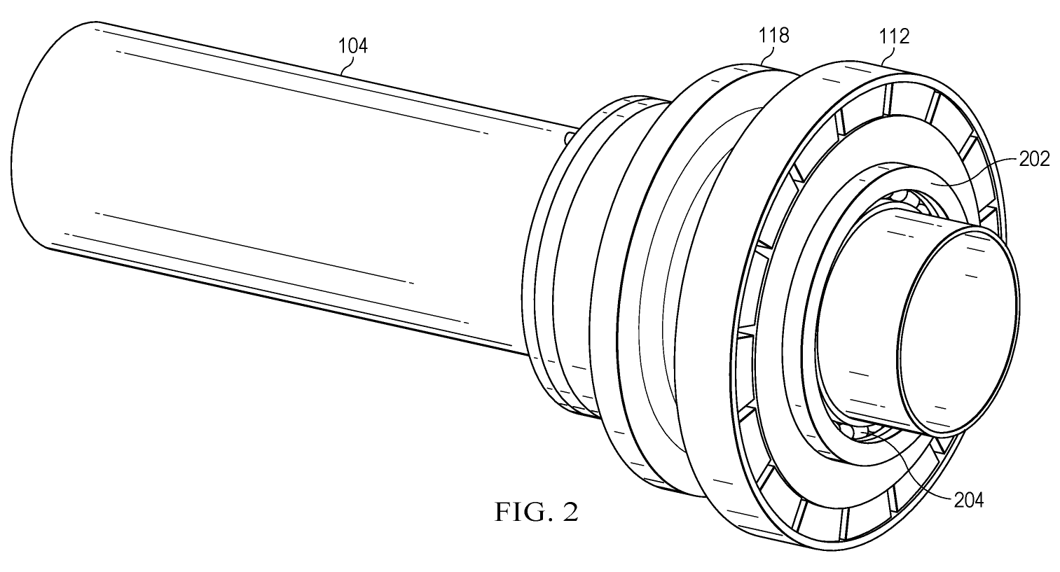

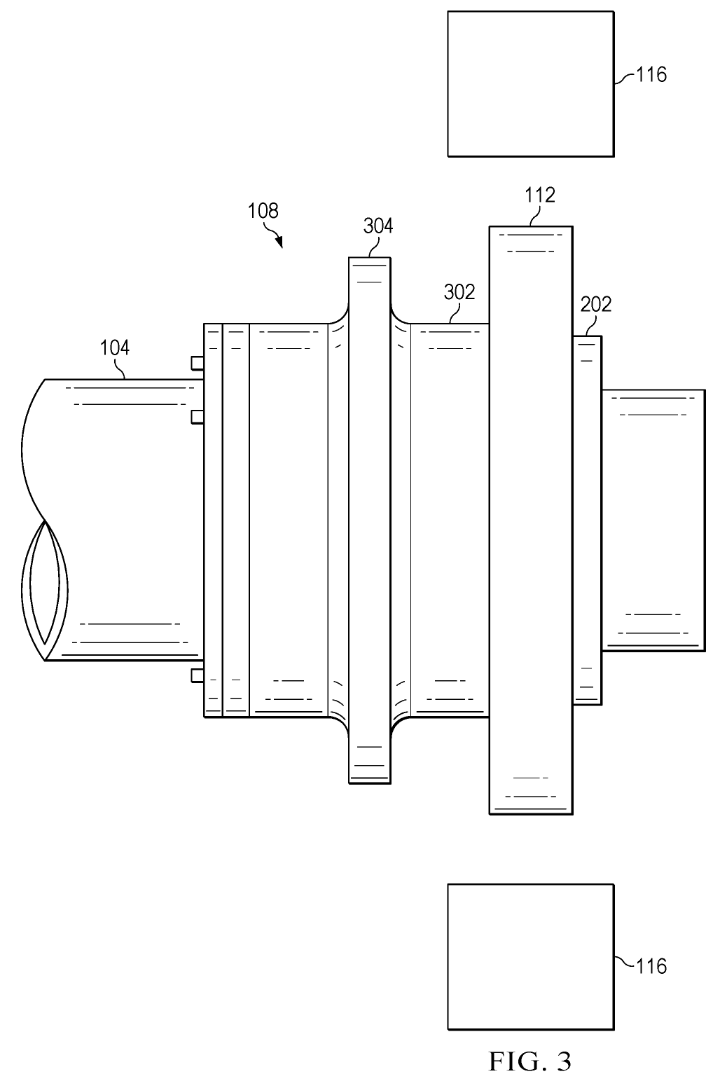

Referring now to FIGS. 2 and 3, there is illustrated a perspective view (FIG. 2) and side view (FIG. 3) of the PMMG rotor 112 and associated drive gear 118 upon a rotor shaft 104 of the ESG 102. As can be seen, the PMMG rotor 112 and drive gear 118 surround the rotor shaft 104 of the ESG 102. The PMMG rotor 112 and drive gear 118 do not directly engage the rotor shaft 104 but are both mounted to an outer concentric shaft 202. The outer concentric shaft 202 rotates about the rotor shaft 104 on bearings 204.

Referring now also to FIG. 3, the PMMG rotor 112, as described previously, rotates responsive to forces applied to the rotor by a current flowing through the stator 116 coil surrounding the rotor 112 of the PMMG 110. The rotor 112 of the PMMG 110 is fixedly connected to the shoulder 302 of the drive gear 118. Integrated with the shoulder 302 are the gear teeth 304 of the drive gear that drive the oil pump 106 via some type of geared connection with the oil pump 106. The shoulder 302 and gear teeth 304 of the drive gear 118 are integrated into a single component that rotates together with the rotor 112 of the PMMG 110 and outer concentric shaft 202.

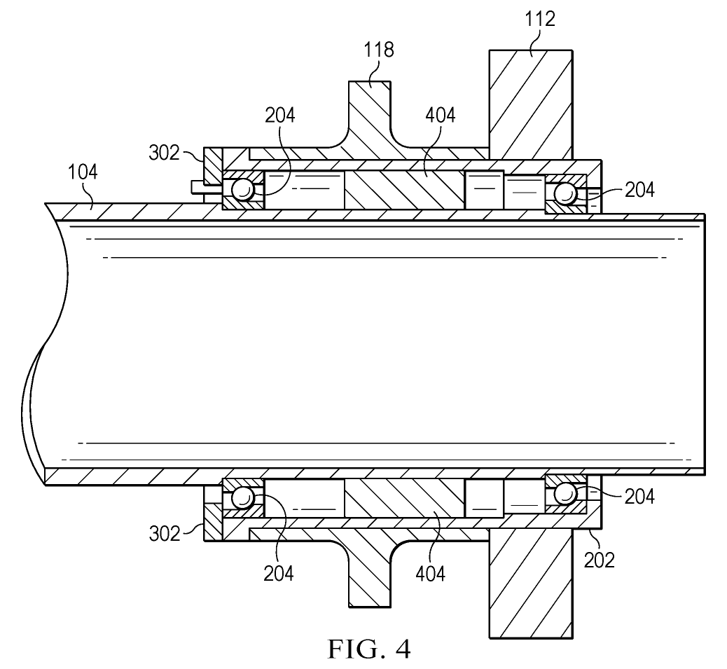

Referring now to FIG. 4, there is illustrated a cross-sectional view of the PMMG rotor 112 and associated drive gear 118 upon a rotor shaft 104 of the ESG 102. As discussed previously, the PMMG rotor 112 and drive gear 118 are fixedly connected to the outer concentric shaft 202. The outer concentric shaft 202 encircles the rotor shaft 104 and rotates about the rotor shaft on bearings 204. Since they are each fixedly connected to the outer surface of the outer concentric shaft 202, rotation of the rotor 112 rotates the outer concentric shaft 202 that also rotates the drive gear 118. The left bearing 204 is maintained in place via a bearing shoulder 302. The bearing shoulder 302 maintains the bearing 204 in place between the outer concentric shaft 202 and the rotor shaft 104.

Additionally included between the outer concentric shaft 202 and the rotor shaft 104 is a one-way clutch 404. The one-way clutch 404 enables the outer housing 202 to rotate in the same direction as the rotor shaft 104 when the rotor 112 is causing the outer concentric shaft 202 to rotate faster than the rotor shaft 104. Thus, if the rotor shaft 104 was stationary or moving slowly during a startup condition, the rotation of the rotor 112 of the PMMG 110 would enable rotation of the outer concentric shaft 202 at a faster speed than currently provided by the rotor shaft 104. Movement of the outer concentric shaft 202 would concurrently move the drive gear 118 enabling operation of the oil pump 106 (FIG. 1) to provide oil to the motor/generator 102 prior to and during startup. The one-way clutch 404 is configured such that when speed of the rotor shaft 104 matches or exceeds the speed of the outer concentric shaft 202 being driven by the PMMG rotor 112, the one-way clutch 404 automatically engages the rotor shaft 104 causing the outer concentric shaft 202 and rotor shaft 104 to rotate concurrently at the same speed and prevent the PMMG rotor 112 from slipping in the opposite direction. At this point, the input current to the PMMG is removed. In this state of operation, the rotation of the rotor shaft 104 will rotate the drive gear 118 and provide operation of the oil pump 106as well as provide generate-mode operation of the PMMG. The addition of the one-way clutch 404 allows for the PMMG rotor 112 to spin separately from the rotor shaft 104 before or during a start operation and drive other accessories such as the oil pump 106 while the motor/generator 102 is not running or is rotating at a speed slower than the speed required to rotate the drive gear 118 at its desired speed.

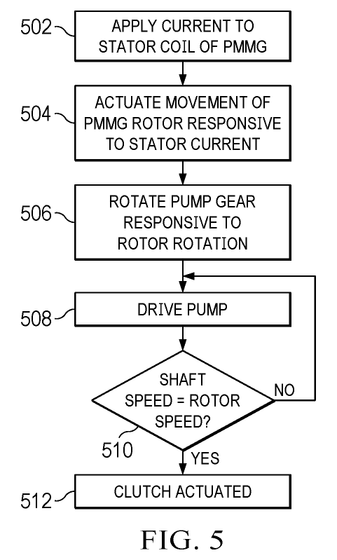

FIG. 5 illustrates a flow diagram of operation of the PMMG 110 associated with the rotor shaft 104 of an ESG 102. The process to provide accessory power to, for example, an oil pump is initiated by applying at step 502 a current to the stator 116 coil of the PMMG 110. This actuates movement of the PMMG rotor 112 at step 504 responsive to the applied stator current. Rotation of the PMMG rotor 112 causes rotation of the drive gear 118 at step 506. The rotation of the drive gear 118 is used to drive the oil pump 106 (or other accessory) at step 508. Inquiry step 510 determines whether the rotational speed of the rotor shaft 104 is equal to the rotational speed of the rotor 112 of the PMMG 110. If not, control passes back to step 508 and the rotation of the rotor 112 continues to drive the oil pump 106 at step 508. When inquiry step 510 determines that the rotor shaft 104 speed equals the rotor 112 speed, it is determined that the one-way clutch 404 has actuated (step 512) and the rotor shaft 104 and rotor 112 are rotating concurrently. In this case, the drive gear 118 is still operating but rotation of the drive gear 118 is caused by the rotor shaft 104 rather than the rotor 112 of the PMMG 110.

This implementation will allow for oil flow during a start event and remove the risk of the components of the ESG 102 becoming overheated. Using the drive gear 118, the design allows for other accessories such as an oil pump 106 to be run while the engine is not operating. However, it would be realized by one skilled in the art that other types of accessories other than the oil pump 106 could be run by the drive gear 118 in a similar fashion.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain examples and generally associated methods, alterations and permutations of these examples and methods will be apparent to those skilled in the art. Accordingly, the above description of example examples does not define or constrain this disclosure. Other changes, substitutions, and alterations are also possible without departing from the spirit and scope of this disclosure, as defined by the following claims.

What is claimed is:

1. An apparatus for driving an accessory comprising:
an electric starter/generator (ESG) including a rotor shaft;
a permanent magnet motor/generator (PMMG) associated with the rotor shaft of the ESG, the PMMG including a rotor and a stator;
a gear coupled to the rotor of the PMMG for rotating in a first mode responsive to rotation of the rotor of the PMMG and for rotating in a second mode responsive to rotation of the rotor shaft, wherein rotation of the gear drives the accessory;
wherein application of a current to the stator of the PMMG is configured to cause rotation of the rotor of the PMMG and the gear coupled to the rotor of the PMMG in the first mode when a rotation speed of the rotor of the PMMG is faster than a rotation speed of the rotor shaft of the ESG; and
wherein when the rotation speed of the rotor shaft of the ESG equals the rotation speed of the rotor of the PMMG, the rotor of the PMMG is configured to engage the rotor shaft of the ESG to rotate concurrently therewith in the second mode.

2. The apparatus of claim 1 further comprising a locking mechanism configured to engage the rotor of the PMMG to the rotor shaft of the ESG in the second mode.

3. The apparatus of claim 2, wherein the locking mechanism further comprises a one-way clutch configured to engage the rotor of the PMMG to the rotor shaft of the ESG.

4. The apparatus of claim 1 further comprising:
an outer concentric shaft surrounding a portion of the rotor shaft of the ESG;
wherein the PMMG rotor and the gear are fixedly connected to an outer surface of the outer concentric shaft; and
a plurality of bearings located between the outer concentric shaft and the rotor shaft of the ESG configured to enable rotation of the outer concentric shaft around the rotor shaft of the ESG.

5. The apparatus of claim 4 further comprising a one-way clutch configured to lock the outer concentric shaft to the rotor shaft of the ESG responsive to the rotation speed of the rotor shaft of the ESG equaling the rotation speed of the rotor of the PMMG in the second mode.

6. The apparatus of claim 4 further comprising a bearing shoulder configured to engage with the outer concentric shaft to maintain the plurality of bearing between the outer concentric shaft and the rotor shaft of the ESG.

7. The apparatus of claim 1, wherein the gear associated with the rotor of the PMMG is configured to drive an oil pump that is configured to provide oil to the ESG prior to and during start-up of the ESG.

8. The apparatus of claim 1, wherein the first mode comprises a pre-start up and start-up mode of the ESG.

9. An apparatus comprising:
an electric starter/generator (ESG) including a rotor shaft;
an outer concentric shaft surrounding a portion of the rotor shaft of the ESG;
at least one bearing located between the outer concentric shaft and the rotor shaft of the ESG configured to enable rotation of the outer concentric shaft around the rotor shaft of the ESG;
a permanent magnet motor/generator (PMMG) associated with the rotor shaft of the ESG, the PMMG including a rotor and a stator, wherein the rotor of the PMMG is fixedly connected to an outer surface of the outer concentric shaft;
a gear connected to the outer concentric shaft configured to rotate in a first mode responsive to rotation of the rotor of the PMMG and configured to rotate in a second mode responsive to rotation of the rotor shaft, wherein rotation of the gear is configured to drive an oil pump configured to provide oil to the ESG;
wherein application of a current to the stator of the PMMG causes rotation of the rotor of the PMMG and the gear connected to the outer concentric shaft in the first mode when a rotation speed of the rotor of the PMMG is faster than the rotation speed of the rotor shaft of the ESG; and
wherein when the rotation speed of the rotor shaft of the ESG equals the rotation speed of the rotor of the PMMG, the outer concentric shaft of the PMMG is configured to engage the rotor shaft of the ESG to rotate concurrently therewith in the second mode.

10. The apparatus of claim 9 further comprising a locking mechanism for engaging the outer concentric shaft to the rotor shaft of the ESG in the second mode.

11. The apparatus of claim 10, wherein the locking mechanism further comprises a one-way clutch configured to lock the outer concentric shaft to the rotor shaft of the ESG responsive to the rotation speed of the rotor shaft of the ESG equaling the rotation speed of the rotor of the PMMG in the second mode.

12. The apparatus of claim 9 further comprising a bearing shoulder configured to engage with the outer concentric shaft to maintain the at least one bearing between the outer concentric shaft and the rotor shaft of the ESG.

13. The apparatus of claim 9, wherein the gear associated with the rotor of the PMMG are configured to drive the oil pump providing oil to the ESG prior to and during start-up of the ESG.

14. The apparatus of claim 9, wherein the first mode comprises a pre-start up and start-up mode of the ESG.

15. A method comprising:
associating a permanent magnet motor/generator (PMMG) including a rotor and a stator with the rotor shaft of an electric starter/generator (ESG);
coupling a gear to the rotor of the PMMG;
applying a current to the stator of the PMMG to cause rotation of the rotor of the PMMG;
rotating the gear in a first mode responsive to rotation of the rotor of the PMMG when a rotation speed of the rotor of the PMMG is faster than the rotation speed of the rotor shaft of the ESG, wherein rotation of the gear drives an accessory associated with the ESG;
engaging the rotor shaft of the ESG to rotate concurrently with the rotor of the PMMG in a second mode when the rotation speed of the rotor shaft of the ESG equals the rotation speed of the rotor of the PMMG; and
rotating the gear in a second mode responsive to rotation of the rotor shaft, wherein rotation of the gear drives the accessory associated with the ESG.

16. The method of claim 15, wherein the step of engaging further comprises locking the rotor of the PMMG to the rotor shaft of the ESG using a one-way clutch in the second mode.

17. The method of claim 15, wherein the step of coupling further comprises:
surrounding a portion of the rotor shaft of the ESG with an outer concentric shaft;
fixedly connecting the PMMG rotor and the gear to an outer surface of the outer concentric shaft; and
locating a plurality of bearings between the outer concentric shaft and the rotor shaft of the ESG to enable rotation of the outer concentric shaft around the rotor shaft of the ESG.

18. The method of claim 17, wherein the step of engaging further comprises locking the outer concentric shaft fixedly connected to the rotor of the PMMG to the rotor shaft of the ESG using a one-way clutch in the second mode.

19. The method of claim 15, wherein the accessory further comprises an oil pump providing oil to the ESG further comprising driving the oil pump with the gear associated with the rotor of the PMMG drives to provide the oil to the ESG prior to and during start-up of the ESG.

20. The method of claim 15, wherein the first mode comprises a pre-start up and start-up mode of the ESG.
